(19) United States
(12) Patent Application Publication
(10) Pub. No.: US 2024/0127536 A1
(43) Pub. Date: Apr. 18, 2024

(54) PROCESS AND DEVICE FOR GENERATING A FLOOR PLAN OF A STORY OF A BUILDING

(71) Applicant: Dräger Safety AG & Co. KGaA, Lübeck (DE)

(72) Inventors: Martin GÜNTHER, Lübeck (DE); Nikolas MÜLLER, Lübeck (DE)

(21) Appl. No.: 18/483,689

(22) Filed: Oct. 10, 2023

(30) Foreign Application Priority Data
Oct. 13, 2022 (DE) 10 2022 126 640.0

(51) Int. Cl. G06T 17/05; G06T 7/73

(52) U.S. Cl. CPC G06T 17/05; G06T 7/73; G06T 2207/10028

(57) ABSTRACT

A process and arrangement automatically generate a floor plan of a building. A set of voxels in the form of polyhedrons is computationally generated and together fill the floor space. The edges of the polyhedron are parallel to the axes of a specified three-dimensional coordinate system. A camera (IR) is moved through the story and generates a sequence of images. The respective position and orientation of the camera (IR) while generating an image are measured. Characteristic key points (S1′, S2′, . . . ) are determined and positioned in the coordinate system. Free voxels (Vx, Vy), i.e. voxels inside a room, are determined. At least one cluster, including a topologically connected set of free voxels, is generated. An enveloping body is placed around each determined cluster. Each enveloping body describes the respective boundaries (W, F) of a room (R.x) of the story.

### CROSS REFERENCE TO RELATED APPLICATIONS

This application claims the benefit of priority under 35 U.S.C. § 119 of German Application 10 2022 126 640.0, filed Oct. 13, 2022, the entire contents of which are incorporated herein by reference.

### TECHNICAL FIELD

The invention relates to a process and an arrangement for automatically generating a floor plan (room plan, layout, floor map) of a story (a floor, a corridor) of a building. A floor plan shows at least approximately the topological shape of rooms of the story, ideally including intermediate (false or drop/suspended) ceilings and slopes.

### BACKGROUND

The task of generating such a floor plan occurs, for example, when a fire has broken out in a building, or the outbreak of a fire is suspected, and therefore the story or the entire building is or can be smoky and firefighters or other rescue personnel do not know the building. Nevertheless, the rescue personnel should be enabled to find their way around the story. In particular, the rescue personnel should be able to rescue humans from the building and also extinguish fire pockets. In many cases, no previously generated floor plan or other floor plan of the story is available to the rescue personnel in such a situation. In addition, an existing floor plan may be outdated.

### SUMMARY

An object of the invention is to provide a method and an arrangement to automatically generate a floor plan of a story of a building, wherein the process and the arrangement shall be more reliable than known processes and arrangements.

The object is attained by a process having process features according to the invention and by an arrangement having arrangement features according to the invention. Advantageous embodiments of the process according to the invention are, as far as useful, also advantageous embodiments of the arrangement according to the invention and vice versa.

The process and the arrangement according to the invention are capable of automatically generating a floor plan for one story (floor) of a building. The process and the arrangement can also be used to generate a respective floor plan for at least two stories of the building. It is also possible that a floor plan should or can be generated for only a part of the story.

The floor plan or each floor plan to be generated includes a floor plan of the story as well as the respective room height for several areas of the story. As a rule, the floor plan describes the story only approximately and not exactly.

The arrangement according to the invention comprises
a camera,
a position sensor, and
a signal processing unit.

The camera is configured to be moved through the or each story for which a floor plan is to be generated, for example, by carrying the camera by a human or an autonomous vehicle. As the camera is moved through the story, it is capable of generating a sequence of images (pictures, frames). It is possible to move multiple cameras successively or simultaneously through the story and to use images from at least two of these cameras. For simplicity, the term “the camera” is used in the following.

The position sensor is capable of measuring a respective indicator for the current position and orientation of the camera at least at each time at which the camera generates an image. Preferably, the position sensor—or at least one transducer (measurement sensor) of the position sensor—is mechanically fixed to the camera. Preferably, the position and orientation of the position sensor or the fixedly connected transducer can be used as the position and orientation of the camera.

The arrangement according to the invention can be configured as a portable device, which is configured to be carried throughout the story. It is also possible that the signal processing unit is arranged spatially remote from the camera and the position sensor, in particular outside the story to which the floor plan to be generated relates, optionally even outside the building. In this case, a respective data connection, preferably a wireless data connection, is at least temporarily established between the camera and the position sensor on the one hand and the signal processing unit on the other hand. In both embodiments, the signal processing unit is able to receive signals from the camera and the position sensor and to process them automatically.

The process according to the invention is carried out using such an arrangement.

A three-dimensional coordinate system with three axes is specified. Preferably, the three axes are perpendicular to each other, i.e. a Cartesian coordinate system is specified. Particularly preferably, two axes are arranged horizontally and span a horizontal plane. Usually, the floors (bottoms) and ceilings in the building extend parallel to this horizontal plane. The third axis is vertical and is perpendicular to this spanned plane. As a rule, the walls in the building and thereby the walls of a story of the building extend parallel to this third axis. It is also possible to use a differently configured or positioned coordinate system.

The process according to the invention comprises the following automatically performed steps, and the arrangement according to the invention is configured to automatically perform the following steps:
A set of voxels is generated. Each voxel is a polyhedron (each voxel is polyhedral-multifaceted), in particular a cuboid (parallelepiped). The edges, and therefore the faces, of this polyhedron are oriented parallel to the axes of the three-dimensional coordinate system. If the coordinate system is a Cartesian coordinate system, i.e. if the three axes are perpendicular to each other, then each polyhedron is a cuboid. Preferably, the voxels are disjoint from each other, i.e. they do not overlap at all or only in one side face each. The voxels together enclose (encircle, encompass) the story for which a floor plan is to be generated (fill the story)—or at least an area of the story for which area a floor plan is to be generated. Preferably, the voxels completely fill the story or the story area. It is possible that the voxels together enclose several stories, for each of which a floor plan is to be generated. The set of voxels can protrude (exceed) the or one story.
The camera is moved through the story. During the process of moving the camera through the story, the camera generates a sequence of images (pictures, frames). Each image of this sequence shows a section of the story.
For each image of the sequence of images, the position sensor measures the respective position and the respective orientation of the camera at the time when the camera generates the image. As the camera's orientation, the position sensor measures in particular the viewing direction of the camera. Preferably, each image of the sequence of images is at least temporarily stored together with a time stamp.
Characteristic key points (landmarks) of the story are determined. Each characteristic key point is located on one respective wall of the story. Of course, several key points can lie on the same wall. Preferably, at least some characteristic key points lie on a respective edge between two walls, particularly preferably on a corner between three walls. To determine the characteristic key points, the images of the sequence of images are evaluated. Each determined characteristic key point is shown in at least one image of the sequence of images.
The characteristic key points are at least approximately positioned computationally in the three-dimensional coordinate system. To position the key points, preferably the respective position and/or the respective orientation of the moved camera are used which the camera has when generating an image with at least one key point.
Free voxels are determined. A free voxel belongs to the set of generated voxels and has the property of being located at least once, i.e. in at least one image of the sequence of images, between the moved camera and at least one key point without any wall or other opaque object being situated between the camera and the voxel. Thus, the key point is shown in the image of the camera. A path from the camera to the key point runs (passes) through the voxel. Usually, a free voxel lies completely or at least with more than half of its volume inside a room of the story.
To determine the free voxels, the determined positions of the characteristic key points and the measured positions and orientations of the moved camera in the three-dimensional coordinate system are used.
One or more clusters are generated. The or every generated cluster forms a topologically connected (coherent) set of free voxels, i.e. consists of such a set. In a topologically connected set of free voxels, a path can always be found that leads from one free voxel of the set to another free voxel of the set and runs exclusively through the set. Thus, the set does not comprise two spatially separated subsets. Each free voxel belongs to at most one cluster. It is possible that a free voxel does not belong to any cluster at all. A voxel inside the cluster is always a free voxel. A voxel at the edge of the cluster is in one embodiment also always a free voxel and in another embodiment not necessarily a free voxel.
A respective enveloping body, for example a cuboid or other polyhedron, is placed around each generated cluster. The cluster is located inside the enveloping body, preferably completely inside. Preferably, the enveloping bodies do not penetrate each another. In one embodiment, each enveloping body is bounded (limited) by vertical side surfaces.
The floor plan is created using the clusters as follows: Each enveloping body enclosing a cluster describes the or at least some boundaries of one respective room of the story, in particular the walls, ceiling and floor (bottom) of the room. The cluster approximately describes the interior of the room itself.

Note: The voxels, key points, and clusters are objects that are computationally generated and at least temporarily stored in a data memory of the signal processing unit. They are “virtual” but not physical objects. The floor plan is a computer-generated representation that can be transmitted to an output unit and be output visually. Of course, it is possible to print out this floor plan. The building, the camera, and the position sensor, on the other hand, are physical (tangible, “real”) objects.

A floor plan is automatically generated by the process and arrangement according to the invention. For this generation, only the images from the camera and a signal from the position sensor are required, but not necessarily a signal from another sensor. The images and the position sensor signal can be generated while the arrangement or at least the camera and a position sensor transducer are carried throughout the story, for example by a firefighter or other rescue personnel while that person is walking through the story. They can also be moved through the story by an autonomous vehicle, such as an unmanned drone. Thanks to the invention, it is possible to generate a floor plan of an unknown building without needing specific information about that building or making specific assumptions. Such special information is often not available when the floor plan is needed. Individual assumptions may be inaccurate. The invention, on the other hand, makes it possible to use general knowledge that applies to most buildings, for example, that walls are arranged vertically, and floors and ceilings are arranged horizontally, and therefore rooms usually have horizontal and vertical bounding surfaces. Thanks to the invention, on the other hand, it is not necessary to assume, in particular, that each room is cuboidal.

While the arrangement is moved or moves through the story, the camera may generate several times in succession images that show the same area of a room on the story. It is possible that the camera generates other images in between. For example, the arrangement with the camera is first moved to a first area, then to another area, and then back to the first area. Thanks to the characteristic key points, in many cases this situation is recognized. This desired effect is achieved because at least some of the characteristic key points differ from one area to another. Thanks to the characteristic key points, it is also often possible to distinguish stationary objects in the story from humans or other living beings moving through the story.

According to the invention, a room of the story is approximately described by a cluster of topologically connected voxels. As a rule, different clusters belong to different rooms. The clusters generated according to the invention represent the rooms of a real building relatively well. The enveloping body around a cluster often describes relatively accurately the walls, the ceiling, and the floor, which together border (limit) this room. The vertical dimension of the enveloping body approximately yields the height of the room.

According to the invention, each generated cluster forms a topologically connected set of free voxels. At the edge of a cluster, a voxel may occur which is not a free voxel, but not in the interior of the cluster. It is also possible that a cluster consists exclusively of free voxels. The feature of forming clusters of free voxels in the interior has the following advantage over the possible approach of forming clusters of occupied voxels, i.e. voxels that each fully or at least partially belong to one wall or ceiling or floor: Usually, only a small part of the story is occupied by walls and ceilings and floors, and the rest is occupied by free spaces (rooms). Thus, a cluster of occupied voxels usually has only a small horizontal extent (dimension) perpendicular to a wall or ceiling, and thus often consists of voxels belonging partly to a wall and partly to a free space of the story. The cluster of occupied voxels therefore poorly describes a wall or ceiling or floor in many cases, especially because the cluster has a strongly curved or jagged or serrated bounding surface, while the wall/ceiling/floor described by that bounding surface is straight. In some cases, two clusters of occupied voxels will intersect, although the walls in question do not intersect in reality.

According to the invention, each free voxel belongs either to exactly one cluster or to no cluster at all, but not to two clusters. The interior of a cluster consists exclusively of free voxels. In one embodiment, an occupied voxel may occur at the edge of a cluster. This occupied voxel lies, for example, completely or at least partially in a wall or ceiling or floor of a room. Preferably, the clusters are formed such that an occupied voxel also belongs to at most one cluster. This increases the reliability that the cluster describes the interior of a room well.

According to the invention, at least one cluster is generated which consists at least in its interior of free voxels. When the generation of a cluster is completed, it is preferably counted how many free voxels still exist, which free voxels are not yet assigned to a cluster. If the number of remaining free voxels is above a specified threshold, the generation of a new cluster is started. Otherwise, cluster generation is terminated, and a respective enveloping body is placed around each generated cluster as described above. One reason for terminating cluster generation: the remaining free voxels together occupy a space that is negligibly small.

In one embodiment, the process of generating a cluster includes the following steps performed automatically:
A free voxel is selected, wherein this free voxel does not yet belong to a cluster. The selected free voxel is used as the first candidate for a new cluster.
It is determined (decided) whether the first candidate is a core voxel or not. What is a core voxel is described below.
If the first candidate is a core voxel, it is the first voxel of the new cluster.
At least once a free voxel is selected as a further candidate. This further candidate also does not yet belong to a cluster.
It is determined (decided) whether the selected further candidate is a core voxel or not.
The generation of the cluster is terminated when a predefined termination criterion is met. In particular, the termination criterion is met when it is determined that no further voxel can be added to the cluster according to the embodiment.

The first candidate and the or each subsequent candidate is a core voxel if the following conditions are met:
The candidate belongs to a topologically connected set of voxels.
The interior of this set consists exclusively of free voxels. It is possible that the entire set consists exclusively of free voxels. It is also possible that at least one voxel occurs at the edge of this set which is not a free voxel. Thus, the set is free of gaps and holes in the interior. One consequence is that the topologically connected set, or at least the interior of the topologically connected set, is completely inside a single room of the story.
The topologically connected set of voxels satisfies a criterion that depends on the number of voxels in the topologically connected set of voxels. In particular, the criterion is satisfied if this number of voxels is greater than or equal to a specified lower threshold.

When determining whether a candidate is a core voxel or not, the topologically connected set is generated on a trial basis, in such a way that topologically connected set of voxels satisfies the above conditions. The set is generated in such a way that the candidate is inside this topologically connected set. It is determined whether this trial basis generated topologically connected set of voxels satisfies the specified criterion.

If the further candidate is a core voxel, the following step is performed: At least one free voxel of the topologically connected set is added to the cluster, where this topologically connected set has been generated on a trial basis (tentatively) and the free voxel does not yet belong to a cluster. In particular, the cluster is extended by the further candidate. Preferably, the cluster is augmented by each free voxel of the tentatively generated topologically connected set. It is possible that a free voxel of this set has already belonged to the cluster before. In this case the free voxel remains in the cluster.

In one embodiment, the cluster is supplemented (extended) by each free voxel of the trial basis generated topologically connected set of voxels that does not already belong to another cluster. In another embodiment, each voxel of the topologically connected set is added to the cluster if that voxel does not already belong to a cluster, even if that voxel is not a free voxel. Also in this embodiment, each voxel belongs to at most one cluster.

Another voxel of the topologically connected set generated so far is selected as another candidate. Preferably, this further voxel is selected as a further candidate regardless of whether the candidate has been classified as a core voxel in the set or not. Preferably, the selected further candidate does not belong to the cluster or to any other cluster so far.

This preferred approach creates the cluster incrementally (stepwise), expanding it at each step until the cluster cannot be expanded any further. In many cases, such a cluster fills a large part of the interior of a room without extending through a wall or passageway into another room.

The termination criterion is fulfilled at the latest when no free voxel in the topologically connected set can be selected as a further candidate by the procedure described above, because all these free voxels of the set already belong to the cluster.

In one implementation of this preferred embodiment, the following steps are performed when determining whether a candidate is a core voxel or not:
As a test (on a trial base), a polyhedron is placed around the candidate. This polyhedron consists of a specified number of voxels being adjacent to each other. The polyhedron thus has the same size for each candidate and is moved computationally from test to test. Preferably, the polyhedron has the shape of a cuboid.
The edges of the polyhedron are parallel to the axes of the three-dimensional coordinate system. The candidate lies in the center of the polyhedron.
The topologically connected set is generated in such a way that it consists exclusively of voxels of the polyhedron.

The implementation with the polyhedron, preferably the cuboid, takes into account the fact that the walls, floors, and ceilings in a building are usually arranged vertically or horizontally, respectively. However, it is also possible to consider a different arrangement of walls, floors, or ceilings or at least not to assume a cuboid shape. Preferably, each polyhedron also has side faces that are arranged vertically or horizontally, but not obliquely. Therefore, in many cases, the configuration with the polyhedra (polyhedrons) leads to the fact that the cluster fills a room relatively well. The side faces of the cluster are often less jagged and curved than may be the case with other possible embodiments.

In the following implementation, a Cartesian coordinate system is specified, and the polyhedron positioned on a trial basis is a cuboid. The vertical dimension of the cuboid can be specified depending on the typical vertical dimension of a ceiling of a building, i.e. the thickness of a ceiling. On the one hand, the vertical dimension should not be too large. As a result, the cuboid does not significantly overhang (protrude) a ceiling in two directions. To achieve that in many cases a room is filled by one cluster and not by two different clusters and that the computing time does not become too long, the vertical dimension should not be too small. The inventors have found in internal experiments that the vertical dimension of a cuboid is preferably between 60 cm and 90 cm and that the cuboid preferably comprises three voxels on top of each other.

In many cases, the further development of the embodiment described above results in the vertical boundary surfaces of a cluster being less jagged and curved than is the case with possible other embodiments.

A further implementation specifies one possible way how to check whether a candidate is a core voxel or not. This further implementation includes the following steps:
By performing a vertical projection, the polyhedron with the candidate in the center is projected onto a horizontal plane. By this projection, all superimposed voxels of the polyhedron are projected onto the same respective n-corner (n-vertex shape or n-corner shape). Thus, by the projection, the polyhedron is projected onto a total n-corner, where this total n-corner consists of single n-corners (vertices, shapes) and each single n-corner (shape) is the projection of the superimposed voxels onto the plane. It may be that the total n-corner has more corners than ever then at least one single n-corner. The candidate is projected onto a single n-corner at the center of the total rectangle.
Preferably a Cartesian coordinate system is specified and the polyhedra are therefore cuboids. The projection then yields rectangles as n-corners.
A single n-corner is created by projecting several superimposed voxels of the polyhedron onto this single n-corner. Each of these superimposed voxels is either a free voxel or another voxel. Depending on how many of the superimposed voxels are free voxels, a single n-corner is classified as a free n-corner or as another n-corner.
A topologically connected set is generated on a trial basis (tentatively generated). According to the implementation, this trial topologically connected set does not consist of voxels, but of individual n corners (n-vertex shapes) of the total n-corners (total n-vertex shapes).
The test is whether the topologically connected set of individual n-corners satisfies (meets) a specified criterion. This criterion depends on the number of individual n-corners of the set. In particular, the criterion is satisfied if the number of individual n-corners is greater than or equal to a specified minimum number. If the criterion is satisfied, the candidate is a core voxel, otherwise it is not.

The embodiments just described provide that a topologically connected set of voxels or individual n-corners is generated on a trial basis. Preferably, this trial topologically connected set is generated stepwise (incrementally, iteratively), starting from the candidate or from the projection of the candidate in the horizontal plane. In the stepwise approach, the set is extended by one voxel or a single n-corner per step, terminating the extension in one direction when a voxel is reached that is not a free voxel. This reached voxel lies at the edge or already outside the set.

According to the invention, clusters consisting of free voxels are generated. A free voxel is situated at least once between the camera and a key point without a wall or other opaque object between the camera and the voxel. Preferably, to determine free voxels, the respective position and orientation of the camera at the moment the image was captured is used for each image that shows at least one key point. This position and orientation is measured by the position sensor.

A preferred embodiment specifies a procedure to automatically decide whether a voxel is a free voxel or not. According to this embodiment, any path that extends from the camera to a key point and passes through the voxel is determined. It is possible that the camera generates images one after the other from different positions and/or orientations, each of these images showing the same key point wherein one path per image extends from the camera to the key point and passes through the voxel. It is also possible that no path at all runs from the camera to a key point through the voxel.

If no path at all runs (passes) through the voxel from the camera to a key point—in general: less than a specified minimum number of paths—then the voxel is classified as unclassifiable. If at least one path—in general: at least the specified minimum number of paths—runs through the voxel, a rating is generated for the voxel. A free voxel is located inside a room, an occupied voxel overlaps at least partially with a wall or ceiling or floor.

Depending on the rating, the voxel is classified as a free voxel or an occupied voxel. The rating depends on the or each path that runs through the voxel. The rating may depend on the number of paths that pass through the voxel. The rating may also depend on whether or not a key point is in the voxel. Preferably, the rating depends on the respective position of a segment of the path relative to the center of the voxel, said segment passing through the voxel. If at least one path passes through the center point or sufficiently near the center point, the voxel is a free voxel with a high degree of certainty (with a certainty above a specified threshold). If all paths intersect only one edge region of the voxel, then the voxel may be partially inside a wall.

For example, the rating is a number between 0 and 1 (inclusive). A rating of 0 means that the voxel is certainly a free voxel, a rating of 1 means that the voxel is certainly an occupied voxel.

The procedure just described leads to the fact that with relatively high reliability a cluster of free voxels being generated according to the invention describes with good approximation the interior of a single room.

According to the invention, characteristic key points are determined and positioned at least approximately in the three-dimensional coordinate system. Further above, an embodiment was described to automatically decide whether a voxel is a free voxel or not. This embodiment relies on determining each path that passes from the camera through the voxel to a characteristic key point. Ideally, each determined key point is located on a wall of the building. Note: The positions of the walls in the coordinate system are usually not known in advance. In practice, however, a characteristic key point can be located in front of or behind a wall, as seen from the camera. The procedure just described or also another possible procedure to determine free voxels can give incorrect results, namely if a key point is positioned in the coordinate system in such a way that the key point lies behind a wall. This could lead to a cluster that overlaps with a wall or even completely penetrates the wall. This, in turn, can lead to an incorrect floor plan. If, on the other hand, the cluster only partially fills the inside of a room, the error is smaller. The following embodiment addresses this problem.

Each key point has an initial position in the three-dimensional coordinate system. This initial position is preferably determined depending on the images of the camera and the signal of the position sensor. Preferably, at least one key point is moved computationally from its initial position towards the camera before the key point is finally positioned in the three-dimensional coordinate system. For this purpose the images showing this key point are used. When the camera generated these images, the camera had a respective position and orientation in the three-dimensional coordinate system. The path over which a key point is moved from the initial to the final position in the coordinate system and thereby towards the camera preferably depends on the respective distance to at least one key point neighboring in the image, in particular on the respective distances to n neighboring key points, wheren >=1 is a specified number. The smaller these distances are, the greater the certainty that the key point is actually on a wall, and the smaller the path over which the key point is moved computationally. One reason: usually a key point is near a wall, even if its position has not been detected correctly.

A cluster created according to the invention approximately describes the interior of a room. An enveloping body is placed around this cluster. This enveloping body describes approximately the boundaries of the room, in particular the walls. An intersection of this enveloping body with a horizontal plane provides a description of the room in a two-dimensional floor plan (2D layout).

In many cases, but not in every time, a room has the shape of a cuboid. This presumption, however, is not necessary. In one embodiment, therefore, a cuboid is placed around a determined cluster as an enveloping body. This cuboid is oriented parallel to the axes of the three-dimensional Cartesian coordinate system, so it preferably has horizontal and vertical bounding surfaces. The cuboid completely envelops the cluster. Preferably, the cuboid has the smallest possible dimensions that a completely enveloping cuboid can have. The volume of the cluster and the volume of the enveloping cuboid are determined. The volume of the cluster is less than or equal to the volume of the enclosing cuboid. The ratio, i.e. the quotient, of the cluster volume and the cuboid volume is calculated. If this ratio is greater than or equal to a specified proportion threshold, the enveloping cuboid is used as the enveloping body. Namely, in this case the cluster has approximately the shape of a cuboid. Instead of a cuboid, a differently shaped polyhedron can also be placed around the determined cluster.

Preferably, the camera is or comprises an infrared camera, which is able to generate images with temperature values from an infrared spectrum, especially preferably from a spectrum between 3 μm and 15 μm. With this configuration, the camera still provides evaluable images even if smoke or dust is present on the story, which is often the case during or after a fire.

Various implementations for the position sensor are possible. In one implementation, the position sensor comprises a geoposition sensor comprising, for example, a GPS receiver. A geoposition sensor, however, is often not able to measure the height over ground. In another implementation, the position sensor comprises a motion sensor (movement sensor) capable of measuring its own current linear motion, preferably its linear acceleration, and its own current angular motion, preferably its current angular acceleration. Such a motion sensor may be implemented as an inertial sensor. The position sensor may comprise a geoposition sensor and a motion sensor.

The signal processing unit evaluates the signal from the motion sensor to generate a trajectory of the camera through the story. Preferably, an initial trajectory is generated based on the signal from the motion sensor. This initial trajectory is corrected using characteristic key points. In particular, a characteristic key point is recognized in different images of the camera. Preferably, the initial trajectory is also corrected by exploiting the fact that the floor surface of the story (the floor) of the building is usually a flat surface or consists of several flat surfaces and therefore the trajectory also extends essentially in one plane. The respective position and orientation of the camera at the time of an image capture are determined with the aid of this trajectory. The term “position sensor” also includes this implementation. Preferably, the trajectory comprises, for each image that the camera has generated, an identification of the point in time at which the camera generated the image.

In the following, the invention is described by means of an embodiment example. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a plan view showing a floor plan of a story (a floor) of a building, said floor plan having been generated in advance and without the use of the invention;

FIG. 2 is a top partially sectional view showing how key points are moved computationally toward the camera;

FIG. 3 is a top partially sectional view showing free voxels in the situation of FIG. 2;

FIG. 4 is a schematic view showing a kernel around a candidate and how voxels of the kernel are projected and classified;

FIG. 5 is a schematic view showing how a cluster is discovered starting from a core voxel;

FIG. 6 is a schematic view showing two core voxels and two kernels around these core voxels in the situation of FIG. 2 as well as two clusters;

FIG. 7 is a schematic view showing the two generated clusters of FIG. 6;

FIG. 8 is a schematic view showing the two clusters of FIG. 7 and, for purposes of illustration, the camera and wall of FIG. 2 in a top partially sectional view;

FIG. 9 is a schematic view showing two cuboids around the two clusters of FIG. 7;

FIG. 10 is a schematic view showing a trajectory through the rooms of FIG. 1;

FIG. 11 is a schematic view showing a floor plan generated according to the invention with the outlines of the rooms.

### DESCRIPTION OF PREFERRED EMBODIMENTS

Referring to the drawings, the invention is used, for example, when a fire has broken out in a building or when it is suspected that a fire has broken out. A so-called initial attack squad (response team) with several firefighters enters the burning building and traverses it, in particular to search for humans in the building and to rescue them, and also to extinguish sources of fire.

As a rule, firefighters do not know the inside of the building. To help them find their way around, it is advantageous to provide them with a so-called floor plan (a room map). This floor plan ideally shows the floor plan as well as slopes and false (drop/suspended) ceilings and/or the room height in rooms. Often, the floor plan additionally shows larger objects in the rooms. Because such a floor plan is usually not available during an operation, it is automatically generated, for which purpose the invention is used.

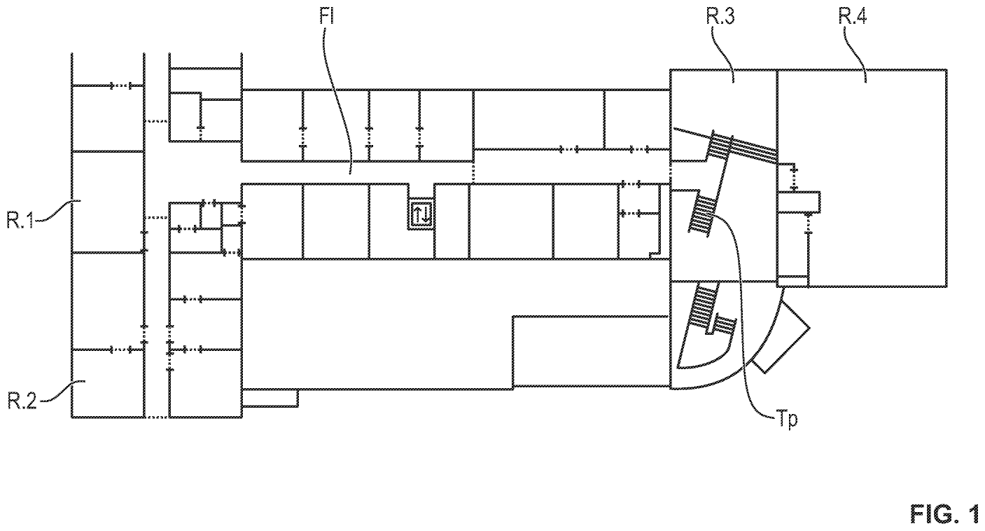

FIG. 1 shows an example of a floor plan of a building, whereby this floor plan was generated in advance and without using the invention. A corridor F1, several rooms R.1, R.2, . . . as well as several stairs (staircases), among them the stair Tp, can be seen.

Every firefighter wears protective equipment. At least one firefighter carries on his or her protective equipment:
an infrared camera (thermal imaging camera) IR,
an inertial sensor unit IMS,
preferably a signal processing unit SP, shown only schematically, which carries out the process according to the invention, as well as
optionally an infrared light source and
optionally a camera for images in the visible wavelength range.

The infrared camera IR is capable of generating images with temperature values from an infrared spectrum, preferably between 3 μm and 15 μm. In one implementation, the optional infrared light source comprises a CO₂ laser that emits light in the wavelength range of 10.6 μm, for example. The essential reason for using an infrared camera IR and optionally an infrared light source is the following: If the building is smoke-filled and/or smoky, cameras that produce images in the visible range (between 350 nm and 750 nm) often do not provide useful results. Typically, the particles in a smoke-filled or smoky room have a diameter between 1 μm and 10 μm. Therefore, at least one infrared camera IR is used, particularly a thermal imaging camera. The or each infrared camera IR used produces images in a wavelength range above 3 μm, preferably above 7 μm.

The inertial sensor unit IMS preferably comprises an accelerometer, which measures the respective linear acceleration in the three directions of an orthogonal (Cartesian) coordinate system, as well as a rotation rate sensor (gyrometer), which measures the three rotational velocities or angular accelerations in this orthogonal coordinate system. In one implementation, the inertial sensor unit IMS additionally comprises a magnetometer, i.e. a sensor which measures the respective strength of the magnetic field caused by the earth in the three directions of the coordinate system. In the embodiment example, the inertial sensor unit IMS functions as the measurement transducer of the position sensor.

The firefighter with the infrared camera IR walks through the building. During this walk, the infrared camera IR continuously generates images, preferably with a fixed scanning frequency. In one embodiment, the infrared light source illuminates the field of view of the infrared camera IR. The firefighter's inertial sensor unit IMS detects the movement of the firefighter, and thus the movement of the infrared camera IR, as the firefighter moves the infrared camera IR through the building. Together, the signal from the inertial sensor unit IMS and the infrared images provide a trajectory that describes the movement of the infrared camera IR through the building. The process of generating a trajectory of a system moving in space has become known as “visual inertial odometry,” but not for the application described here.

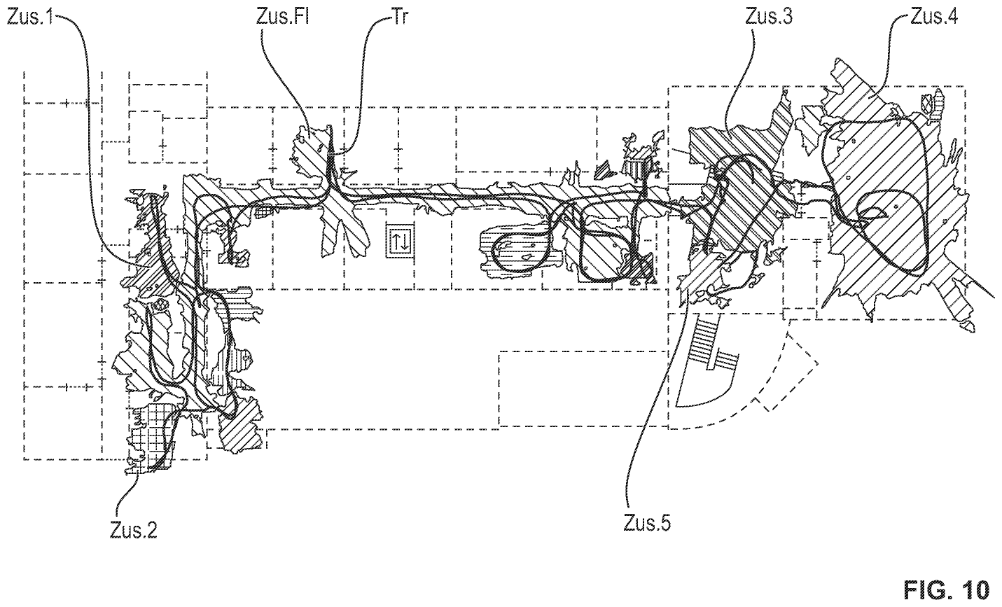

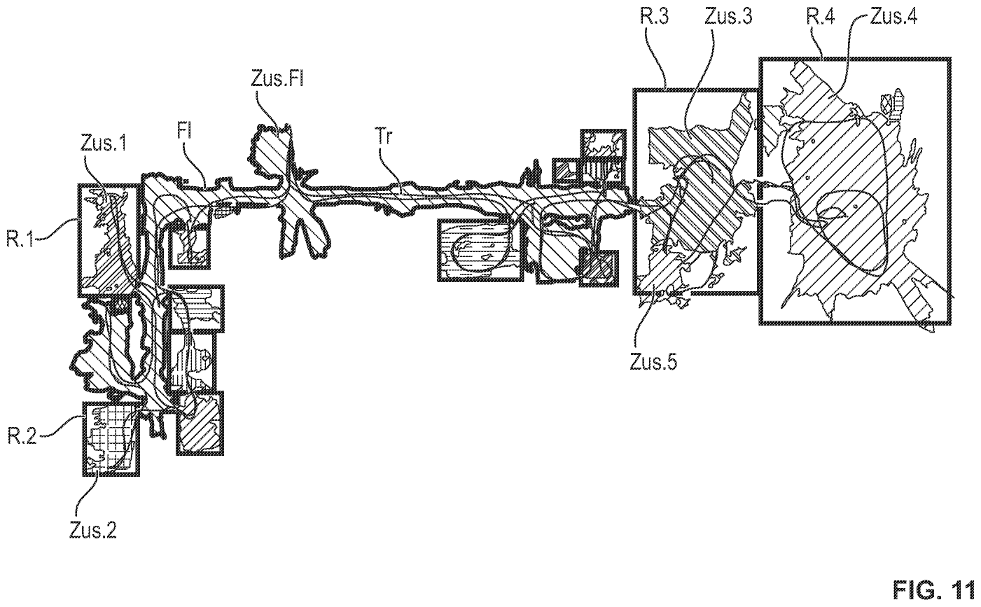

FIG. 10 and FIG. 11 show an example of a trajectory Tr through the story shown in FIG. 1. This trajectory Tr was generated automatically using a signal from the inertial sensor unit IMS. The remaining components of FIG. 10 and FIG. 11 are explained below.

A stationary three-dimensional coordinate system is specified. The x-axis and the y-axis are arranged horizontally, the z-axis vertically. The trajectory Tr is positioned in this coordinate system.

It is possible that the firefighter walks through the same room of the building several times with the infrared camera IR. Therefore, it is also possible that several images from the infrared camera IR show the same area of the same room, often from different viewing directions. To detect this event, the system automatically searches for characteristic visual features in the infrared images. Such characteristic features are also referred to as “landmarks”. A characteristic feature usually refers to a point in the building, is defined by its surroundings and is then called a “key point”. A characteristic feature in an image, and thus in an infrared image, is generally an area of the image with characteristic properties. An example of a characteristic feature in an image is an image region showing the intersection of at least two edges of a space of the building, i.e., a corner point (vertex) in the room. Preferably, the corner point is treated as a characteristic feature. A characteristic feature, in particular the image of a corner point, has the property that the characteristic feature can be automatically recognized with relatively high certainty in different images, even if these images show the characteristic feature from different viewing directions and/or from different distances and therefore with different imaging scales. In many cases, a process based on such characteristic features, especially corner points, is robust against rotations and translations.

Frequently, a characteristic feature in at least one image is an image of a characteristic key point. Detected key points are also detected in two-dimensional images and positioned, in particular projected, in the three-dimensional coordinate system described above. To position a key point in the three-dimensional coordinate system, the position and orientation that the camera IR has at the time of capturing that image that shows the key point are used.

Note: The images of the camera are known to be two-dimensional objects and show characteristic image features. A characteristic image feature can be a key point in the building, for example a corner where three walls meet, or just the corner of a different colored area on a wall, for example a painting or poster. Preferably, different images in which the same characteristic image feature is shown are compared to each other to automatically decide whether this characteristic image feature shows a characteristic key point in the building or something else.

In order to detect corner points and other key points, in one implementation, the process is used as described in J. Shi & C. Tomasi: “Good Features to Track”, IEEE 19/94, pp. 1063-1069 (Shi & C. Tomasi: “Good Features to Track”, IEEE 19/94, pp. 1063-1069 is incorporated by reference).

Preferably, the signal is evaluated by the inertial sensor unit IMS to generate an initial trajectory. This initial trajectory is corrected using characteristic key points. Here, it is determined whether the same characteristic key point occurs in different images of the camera IR, and this event is used to correct the initial trajectory.

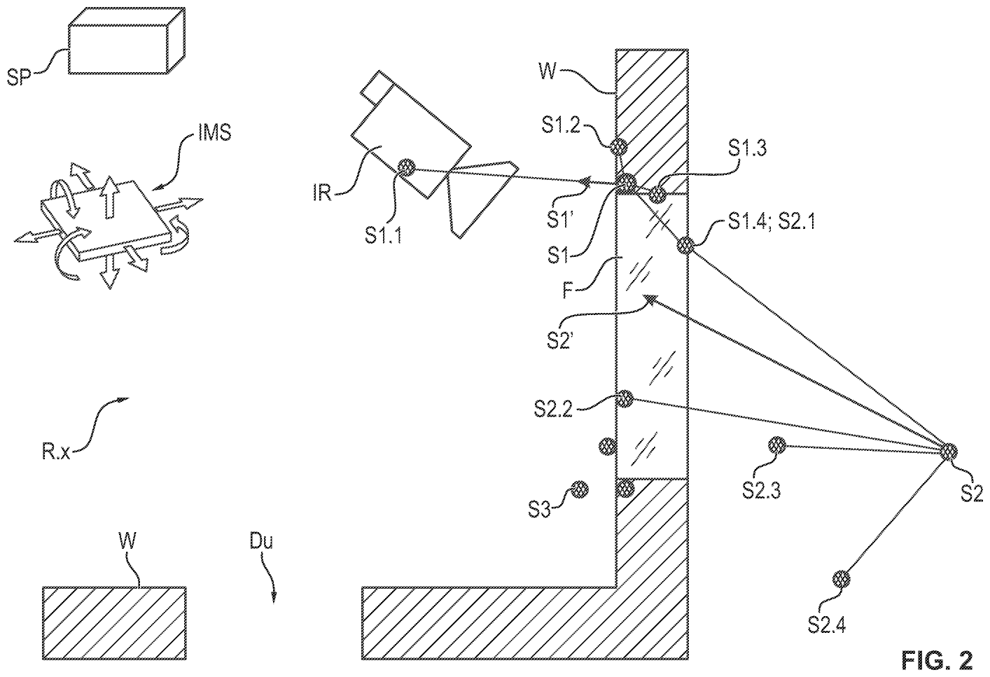

FIG. 2 shows an example of a top view of a wall W of a room R.x, with a window F and a passage Du are embedded in and open into the wall W. Furthermore, FIG. 2 shows the infrared camera IR in this room R.x. The position and the orientation of the infrared camera IR at a certain point of time is described by a so-called 6D pose. Preferably, the assumption is used that the measured 6D pose matches the actual position and orientation of the infrared camera IR. Three components of this 6D pose describe the position, three further components the orientation in the three-dimensional coordinate system. Preferably, a 6D pose can be described as an element of a Lie group SE(3).

Several key points S1, S1.1, . . . , S2, S2.1, S3, . . . Ideally, all key points are located on one wall W of the room. It can be seen that individual key points, on the other hand, are located in front of the wall W or outside the room, e.g., the key point S2. This undesired event occurs in particular at the window F.

In order to compensate for this effect at least approximately, key points are preferably moved closer to the infrared camera IR by calculation. This is described by way of example for the two key points S1 and S2 with reference to FIG. 2. A number k>=1 is specified. k=4 in the embodiment example shown. The k closest key points are determined for each key point. In the embodiment example, the k=4 key points S1.1, . . . , S1.4 are the key points nearest to the key point S1, and the k=4 key points S2.1, . . . , S2.4 are the key points nearest to the key point S2. As can be seen, there is one key point in the infrared camera IR itself, namely the key point S1.1. In the process of moving key points closer to the infrared camera IR, the key point S1 is mapped to the key point S1′, and the key point S2 is mapped to the key point ST. Instead of S1 and S2, S1′ and S2′ are used in the following process steps.

According to an implementation of this computational shifting, three factors f_{kNNdamping}, f_{stretching}, f_{damping} are specified. For each key point Si, a factor fi is determined according to the formula fi=median {0, 1−x1/x2, 1}. Here

x1=min{dist(Si,Si.1),dist(Si,IR)}+ . . . +min{dist(Si,Si.k),dist(Si,IR)},x2=k*f_{kNNdamping}.

In addition,

Pos(Si′)=Pos(Si)+fi*dist(Si,IR)*f_{stretch}*[Pos(Si)-Pos(IR)]+[Pos(Si)-Pos(IR)]/[dist(Si,IR)*f_{damping}].

Pos(IR) denotes the position of the infrared camera IR in the three-dimensional coordinate system, Pos(Si) the position of the key point Si (i=1, 2, . . . ). Dist(Si,IR) is the distance between the key point Si and the infrared camera IR.

In order to determine the three factors f_{kNNdamping}, f_{stretching}, f_{damping}, in one embodiment a sample with several key points is generated. An error function is minimized. The error function to be minimized is the summed distance between the key points and the nearest wall. Ideally, all key points are located on one wall each W. The three factors f_{kNNdamping}, f_{stretching}, f_{damping} are the three variables of this error function.

The infrared camera IR has an approximately cone-shaped field of view. Imaginary beams emanate from the camera and lie within this field of view. A path of this beam between the infrared camera IR and a computationally corrected key point runs completely through a free space.

In the three-dimensional coordinate system, a cuboid is positioned in which the building to be examined is located. Furthermore, cuboid elements are positioned in the coordinate system in such a way that the entire cuboid for the building is filled with cuboid elements and the cuboid elements are directly adjacent to each other without overlapping. Such a cuboid element is hereinafter referred to as a “voxel”. Preferably, the cuboid for the building is divided into the cuboid elements, i.e. each point of the cuboid belongs to a voxel, and the voxels do not overlap. In one embodiment, each cuboid element has the shape of a cube. Instead of cuboids, differently shaped polyhedra can also be used.

Preferably, the voxels are disjoint to each other and adjacent to each other. Preferably, the voxels are defined by a grid. In order to store this grid in such a way that the position and the extent of a voxel in the coordinate system can be quickly determined, the voxel grid is preferably represented in a data memory by a so-called octree. An octree is a tree structure that divides a volume in each plane into eight equally sized cuboids. In one embodiment, eight voxels (cuboids) in one level of this tree that are classified the same are replaced by a single voxel with the same classification. In particular, this applies to eight free voxels in a plane. This replacement can also be continued in the layer above.

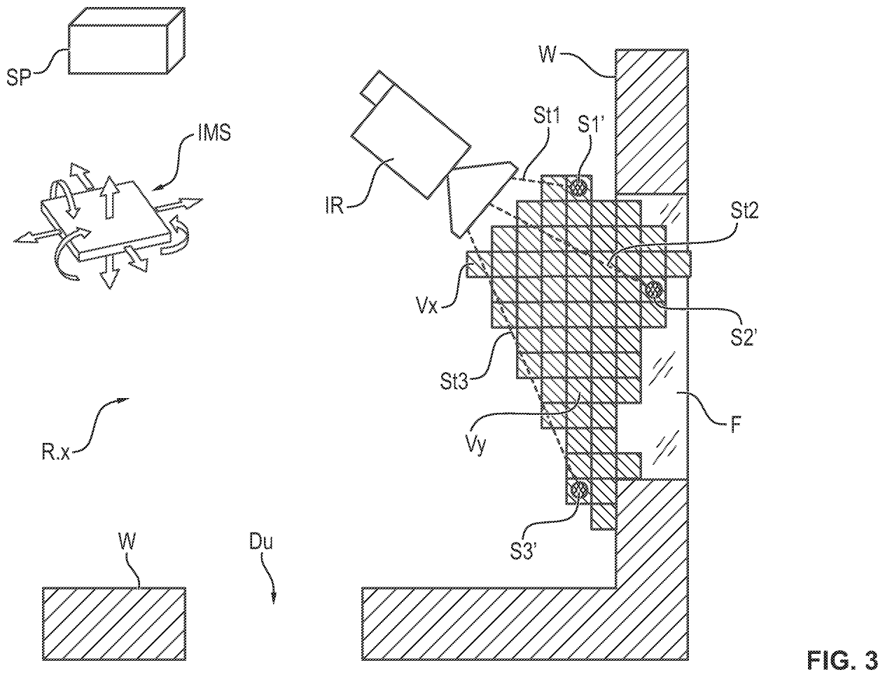

FIG. 3 shows in a top view the situation of FIG. 2 with computationally shifted key points S1′, S2′, S3′, . . . and exemplarily three paths St1, St2, St3, which run from the infrared camera IR to the three key points S1′, S2′, S3′. Also, exemplarily, two voxels Vx and Vy are designated. All voxels through which a path St1, St2, St3 passes are free voxels in this viewing direction. For illustration purposes, the wall W, the window F, and the passage Du are shown in FIG. 3. Their positions are not known in advance.

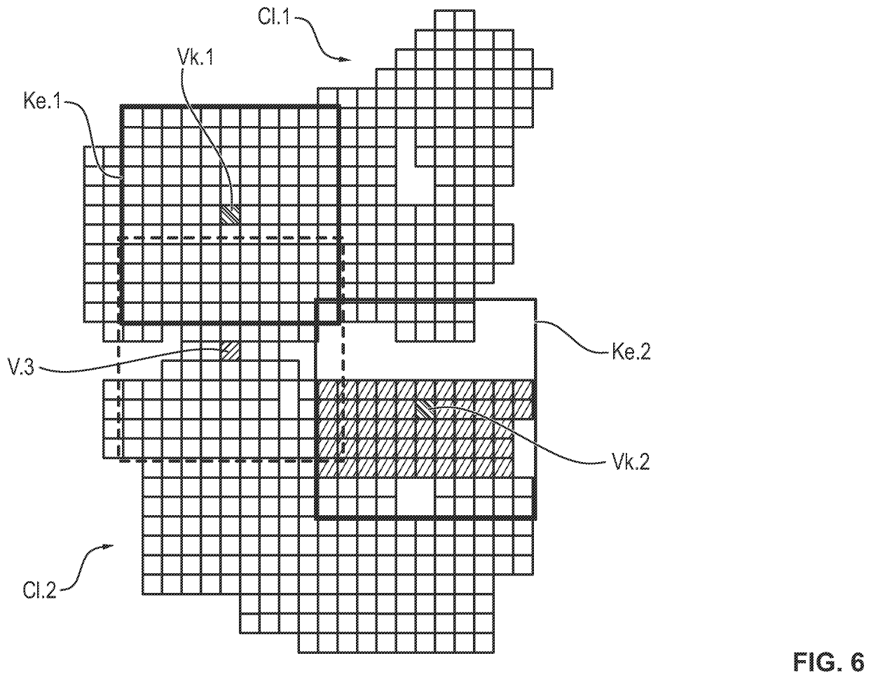

A basic idea of the process is the following: Key points in images from the infrared camera IR are detected and positioned in the three-dimensional coordinate system, for example by projecting. All voxels on the path from the infrared camera IR to a key point are marked as free. The voxels Vx, Vy marked as free are shown in FIG. 3 as examples. FIG. 6 shows exemplary free voxels in a top view, i.e. from above.

FIG. 3 and following Figures show a simplification in a plane Eb. In practice, the infrared camera IR generates images successively from different positions and in different viewing directions. It should be taken into account that the position and orientation of the infrared camera IR, which are determined by means of the inertial sensor unit IMS, may differ from the actual position and orientation at that time. In addition, there may be humans in the building and also objects that are moving while the infrared camera IR and the inertial sensor unit IMS are moving through the building. Therefore, it can happen that one and the same voxel from one position and in one viewing direction at one point in time is classified as a free voxel and from another position and/or in another viewing direction and/or at another point in time is classified as an occupied voxel.

As a rule, key points are positioned at a boundary of a room, but not inside this room. Therefore, an occupied voxel is usually not located inside a room, but e.g. on a wall or a ceiling, slope, false ceiling or on some other rigid object in the room. The fact that the infrared camera IR is located inside a room, while the key points are usually located at the edge, has the following consequence: a free voxel in the center of a room is often intersected by many lines emanating from the infrared camera IR, while a free voxel at the edge of the room is intersected by only a few lines. The opposite result is also possible, especially if the infrared camera IR is frequently used near a wall.

For each voxel, a total rating is determined for the fact that this voxel is occupied. Preferably, the total rating is a number between 0 and 1, which can be understood as a probability. A total rating of 1 means that the voxel is certainly occupied, one of 0 that the voxel is certainly free. The overall rating for a voxel is derived from the or each individual rating for that voxel, where each individual rating refers to a path between the infrared camera IR and a key point, and results in all voxels on that path being marked as free. The voxel in which the key point is located is not marked as a free voxel. Optionally, each individual rating is also a number between 0 and 1. The uncertainty in the individual rating results in particular from the fact that a voxel can lie partly in free space and partly in a wall and a path can run through the free part of the voxel and in particular can intersect only an edge region of the voxel.

In one embodiment, each individual rating is a logarithmic probability, and the total rating for a voxel is determined by summing the individual ratings for that voxel. The sum of the individual ratings is the logarithm of the total rating sought.

Depending on the overall rating obtained, it is decided whether a voxel is a free voxel, an occupied voxel, or an unclassifiable voxel. Such a procedure is described in A. Hornung, K. M. Wurm, M. Bennewitz, C. Stachniss & W. Burgard, “OctoMap: An efficient probabilistic 3D mapping framework based on octrees”, Autonomous Robots Vol. 34 No. 3, pp. 189-206, 2013, but not for the application described here (A. Hornung, K. M. Wurm, M. Bennewitz, C. Stachniss & W. Burgard, “OctoMap: An efficient probabilistic 3D mapping framework based on octrees” is incorporated by reference).

In the embodiment example, a lower threshold n_{Bew,min} for the number of paths that must intersect a voxel and a threshold pₜₕᵣ between 0 and 1 are specified. A voxel is not classifiable if fewer than n_{Bew,min} paths intersect this voxel. The minimum number n_{Bew,min} can be 1, and a voxel is unclassifiable exactly if no path intersects this voxel. A voxel intersected by at least n_{Bew,min} paths is a free voxel if its total rating is less than p r y, and an occupied voxel otherwise.

The procedure described below detects contiguous free spaces on the story one after the other. A contiguous cluster of free voxels forms one room. Each free voxel belongs to at most one cluster. In the following it is described how such clusters are created step by step in the three-dimensional coordinate system.

The process uses so-called kernels, which are placed tentatively around free voxels. A use of circular kernels is described in M. Ester, H. P. Kriegel, J. Sander & X. Xu: “A density-based algorithm for discovering clusters in large spatial databases with noise”, kdd, Vol. 96 No. 34, pp. 226-231, 1996 (M. Ester, H. P. Kriegel, J. Sander & X. Xu: “A density-based algorithm for discovering clusters in large spatial databases with noise”, kdd, Vol. 96 No. 34, pp. 226-231, 1996 is incorporated by reference). This process is referred to as DBSCAN.

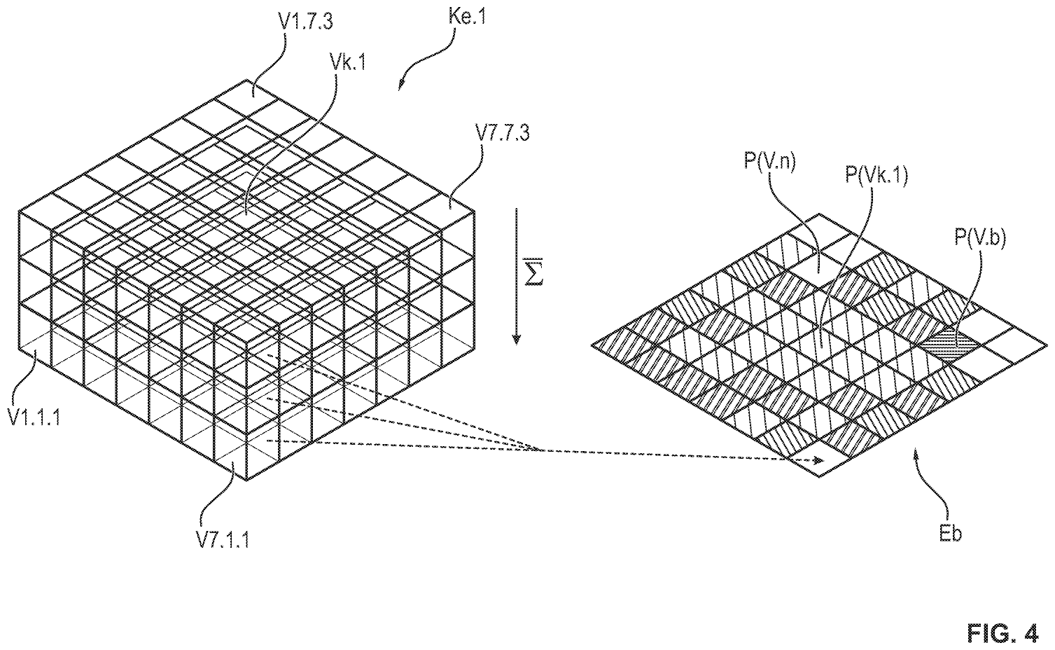

In the embodiment, however, a kernel is a cuboid that is aligned parallel to the axes of the three-dimensional coordinate system and is successively placed around one voxel at a time on a trial basis, in such a way that the voxel is located in the center of the kernel. This embodiment takes into account the fact that the walls, floors and ceilings in a building are usually arranged horizontally or vertically, that is, parallel to the axes of the Cartesian coordinate system. In one implementation of the embodiment, each kernel consists of 7*7*3 voxels, namely 7 voxels each side by side in the x-direction and y-direction and 3 voxels one above the other in the z-direction. In the example, the kernel has N=147 voxels. Such a kernel Ke.1 is shown in FIG. 4 on the left. Exemplary the voxels V1.1.1, . . . , V.7.7.3 are shown. It is also possible that a kernel has a different number of voxels, e.g. N=11*11*3 voxels, cf. FIG. 6.

Preferably, all voxels have the same dimensions. One parameter of the process according to the invention is the vertical side length of a voxel. This vertical side length can be determined in advance, depending on an expected or typical thickness, i.e. vertical dimension, of a ceiling. In the embodiment example, a thickness of a ceiling of 30 centimeters is assumed. Each vertical side length of a voxel is preferably between 20 cm and 30 cm. A physical reason for this dimension is: the height of a kernel with three voxels on top of each other is between 60 cm and 90 cm. One reason: If you put the kernel around a voxel in a room, the kernel overhangs the voxel by a distance upwards or downwards, the thickness of which is at most between 30 cm and 45 cm. This distance is less than the assumed thickness of a room ceiling. Thus, a kernel does not overhang a ceiling on two sides. Thus, the process according to the invention makes it possible to distinguish several rooms lying on top of each other with a high degree of reliability.

Preferably, each horizontal side length of a voxel is also between 20 cm and 30 cm. If a kernel comprises at least six voxels each in each horizontal extent, i.e., length and width, then each horizontal dimension of the kernel is larger than a typical horizontal dimension of a door or other passageway between two rooms of a building. This feature reduces the risk of the same cluster comprising parts of two different rooms, which would be an error.

First, the basic idea of how such clusters are formed is described, and then a preferred refinement is presented. Both the basic idea and the refinement take into account the fact that the process is applied in a building and the building usually has rooms with vertical and horizontal boundaries (walls, ceilings, floors) enclosing rooms, where each room is the shape of a cuboid or a composition of several cuboids, but does not have an arbitrary geometric shape.

According to the basic idea, a cluster is created step by step as follows:

A minimum number nₘᵢₙ, is specified. If the kernel has the size of N voxels, then nₘᵢₙ, is a number greater than or equal to N/2 and smaller than N. In the example shown, N=7*7*3=147 and nₘᵢₙ is 100.

First, the first voxel of a new cluster is searched for by the following steps:
A voxel classified as free is randomly selected as the start voxel. The start voxel is the first candidate for the new cluster.
The cuboid kernel is placed around the start voxel in such a way that the start voxel is in the center of the kernel.
The number of free voxels in the kernel around the start voxel is counted.
If this number of free voxels in the kernel is greater than or equal to the minimum number nₘᵢₙ, the start voxel in the center of the kernel is a so-called core voxel and belongs to a new cluster.
Otherwise, another voxel classified as free is randomly selected as the start voxel, and the steps just described are performed for this further voxel. The kernel is thus placed around this further voxel.

Then, this cluster is extended stepwise by more voxels until a termination criterion is met. The stepwise expansion is done by the following steps:
The previous step in each case provided a kernel with a voxel at the center of that kernel, with that voxel classified as a core voxel and therefore already belonging to the cluster.
The cluster is extended by at least one, and preferably by every other free voxel in this kernel.
One by one, each additional free voxel in this kernel is marked as a candidate.
The kernel is placed around each candidate in turn, with the candidate at the center of the kernel.
It is counted whether there are at least nₘᵢₙ, other free voxels in the kernel around the candidate.
If this is the case, at least one free voxel of the kernel is added to the cluster, preferably every free voxel.

By this procedure, the cluster is created step by step and is extended in each step. The termination criterion is met and the cluster is finished when the procedure just described does not yield another voxel belonging to the cluster—in other words, when every candidate found in this way has been examined and no new candidates are added.

The application of the basic idea leads to a cluster consisting of core voxels. Around a core voxel there are more free voxels. This minimizes the risk of a cluster protruding into a wall, which would be an incorrect result.

However, this basic idea can still lead to incorrect results. This is because the basic idea only considers the number of free voxels in a kernel, but not the position of the free voxels relative to the candidate at the center of the kernel. It is possible that two different voxels in the same kernel around the candidate belong to two different rooms, for example because a wall between these two rooms runs through the kernel. The basic idea just described could cause these two voxels to be marked as belonging to the same cluster, even though they are in two different rooms. This undesirable effect could be avoided by setting the minimum number nₘᵢₙ to a high value, i.e., close to N. However, then it may happen that two disjoint clusters are formed for one room instead of a single cluster. This can also lead to an incorrect result.

Subsequent refinement of the basic idea reduces the risk of producing such an incorrect result.

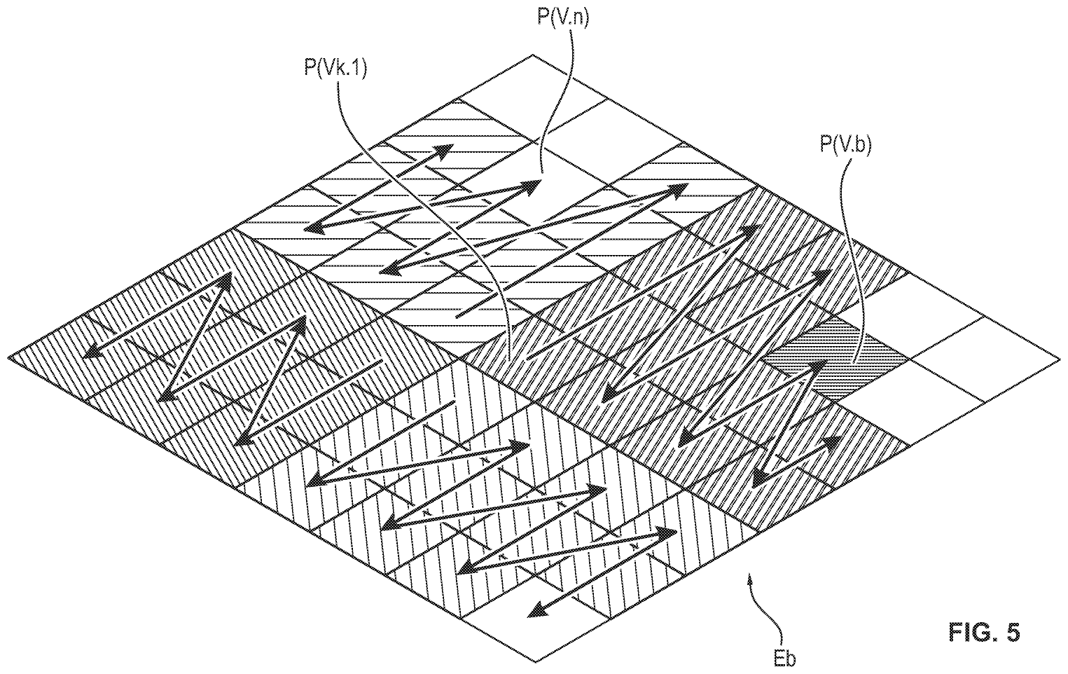

In the following, two implementations with this refinement are described with reference to FIG. 4 and FIG. 5. Both implementations of the refinements concern the criterion for deciding when a candidate is classified as a core voxel and therefore considered to belong to a cluster. Both implementations replace counting by a different procedure.

FIG. 5 shows a horizontal plane Eb passing through a kernel. The intersection or projection of a voxel with this plane Eb is a rectangle, in the case shown as a square. The rectangle P(Vk.1) belongs to the candidate voxel Vk.1, the rectangle P(V.b) belongs to a voxel V.b classified as occupied, and the rectangle P(V.n) belongs to an unclassifiable voxel V.n.

The first implementation of the refinement is carried out throughout the kernel, just like the basic idea. The voxel (the candidate) Vk.1 is located in the center of this kernel. Starting from the candidate Vk.1, a topologically connected and gap-free three-dimensional set of voxels is determined in the kernel. This set is bounded at its edges by occupied voxels, unclassifiable voxels, and the rectangular side faces of the kernel. In the interior, this set consists exclusively of free voxels. “Topologically contiguous” means: Two voxels of the set are immediately adjacent or can be connected by a line segment, where the line segment passes exclusively through the set. “Gap-free” means: There is no voxel inside the set that does not belong to the set. In other words: A voxel that does not belong to the set is adjacent to a side face of the kernel or can be connected to a side face by a path that is completely outside the kernel.

FIG. 5 illustrates the procedure to generate a topologically connected and gap-free set by means of arrows lying in the plane Eb. In the first implementation, however, starting from the candidate Vk.1, the set is “wandered” in all six directions in space, i.e. also perpendicular to the plane Eb. In the first implementation the found topologically connected and gap-free set is bounded by the voxels V.b and V.n, among others.

The first implementation counts how many voxels make up the topologically connected and gap-free set in the kernel around Vk.1. This number of voxels is in turn compared to a specified minimum number nₘᵢₙ. If the number is greater than or equal to the minimum number nₘᵢₙ, then the candidate Vk.1 is a kernel voxel and belongs to the new cluster or to the already created cluster, respectively. Each free voxel in the topologically connected and gap-free set is a candidate to be a core voxel and therefore to belong to the same cluster as the voxel Vk.1 in the center. This candidate is in turn examined, for which a kernel is again placed around the candidate.

This first implementation usually avoids the defect that a cluster at least partially covers two rooms, these two rooms being separated by a wall. In many cases, however, this first implementation results in relatively jagged or otherwise irregular edges of the clusters, particularly in the intersection of the cluster with a vertical plane. A room in a building, on the other hand, is usually bounded by vertical walls and horizontal floors and ceilings. The second implementation in many cases leads to smoother boundaries of the clusters.

In the second implementation, the kernel is projected onto a plane by a vertical projection, i.e. a projection parallel to the z-axis. FIG. 4 shows an example of how the kernel Ke.1 (left) is projected onto the plane Eb (right). This plane Eb is also shown in FIG. 5. Each voxel in the kernel is projected onto a rectangle, for example the voxels Vk.1, V.n, V.b are projected onto the rectangles P(Vk.1), P(V.n), P(V.b). Because in the example shown the kernel has 7*7*3 voxels, the projection into the plane Eb has 7*7=49 rectangles.

In the shown embodiment example, the kernel has an extension of n=3 voxels in z-direction. In each case n=3 superimposed voxels are projected onto the same rectangle in the plane Eb. It is counted how many of these n superimposed voxels are classified as free or as occupied. The remaining voxels are not classifiable.

A minimum number of n_{Proj,min}<=n, e.g. n_{Proj,min}=1 or n_{proj,min}=2, is specified. If at least n_{proj,min} voxels of the n superimposed voxels are classified, an overall rating of the rectangle onto which the n superimposed voxels are projected is calculated from the overall ratings of the n_{proj,min} superimposed classified voxels. For example, the arithmetic mean is calculated over the total ratings of the n_{proj,min} superimposed classified voxels. Depending on this total rating of the rectangle, the rectangle is evaluated as free or occupied. For this the above mentioned threshold pair is applied. If less than n_{Bew,min} of the n superimposed voxels projected onto a rectangle are classified, the rectangle is also considered as unclassifiable.

In the example of FIG. 4, the rectangle P(V.b) is occupied, the rectangle P(Vk.1) is free, and the rectangle P(V.n) is unclassifiable. In FIG. 4 on the right and in FIG. 5 three types of rectangles are shown:
free rectangles [shown with vertical or angular hatching, e.g., P(Vk.1)], which are rectangles with a rating less than pₜₕᵣ,
occupied rectangles [shown with double line horizontal hatching, e.g., P(V.b)], which are rectangles with a rating equal to or greater than pₜₕᵣ, and
unclassifiable rectangles [shown with no hatching, e.g., P(V.n)], which are rectangles with fewer than n_{Proj,min} free or occupied voxels projected onto them.

In FIG. 4 the threshold pₜₕᵣ is equal to 0.8, e.g. At least two different ratings smaller than the threshold pₜₕᵣ are possible. Therefore two different kinds of vertical or angular hatchings for free rectangles are shown in FIG. 4 and FIG. 5. Free rectangles are shown by different kinds of vertical or angular hatchings, occupied rectangles by horizontal hatching.

In the second implementation, a two-dimensional topologically connected and gap-free set is formed in the plane Eb. The projection P(Vk.1) for the candidate Vk.1 lies in this topologically connected and gap-free set. To form this set, those free rectangles (projections of voxels) are searched which are directly or indirectly adjacent to the projection P(Vk.1) of the candidate Vk.1. This is illustrated in FIG. 5 by the arrows in the four directions in the plane Eb. The two-dimensional topological connected and gap-free set is bounded by the occupied rectangles, the unclassifiable rectangles and by the edges of the plane Eb.

In the example shown, 2+3=5 rectangles do not belong to the topologically connected and gap-free set and are not crossed over by an arrow. The remaining 7*7−5=44 rectangles belong to the topological set and are crossed by at least one arrow each.

The number of rectangles belonging to the topologically connected and gap-free set is counted. If this number is greater than or equal to a specified minimum number, then candidate Vk.1 is a kernel voxel and free voxels from the kernel are added to the cluster, otherwise not.

As explained above, other candidates in the kernel centered around the core voxel Vk.1 are selected and it is determined if they are also core voxels. According to the second implementation, not all voxels in the kernel around Vk.1 are selected. Rather, a back projection is performed to select the other voxels that will now become candidates.

In the back projection, we first select each rectangle in the projection of that kernel onto the plane Eb which cumulatively satisfies the following properties:
The rectangle is a projection of a voxel of the kernel Ke.1 around Vk.1 onto the plane Eb.
The rectangle is classified as free or occupied.

Then, each free voxel in the kernel Ke.1 is selected around Vk.1, which satisfies the following property: The free voxel was projected onto a selected rectangle in the plane Eb during projection. Each free voxel in kernel Ke.1 selected in this way is a candidate to belong to the cluster as well.

FIG. 6 shows a top view of the voxels of FIG. 4 and, as an example, the two projections of two core voxels Vk.1 and Vk.2. In this example, each kernel consists of 11*11*3 voxels. Two rectangles are shown, namely the projections of the two kernels Ke.1 around the core voxel Vk.1 and Ke.2 around the core voxel Vk.2 onto the drawing plane. The two core voxels Vk.1 and Vk.2 belong to two different clusters C1.1 and C1.2, i.e., lie in two different rooms. The two clusters C1.1 and C1.2 are created as illustrated with reference to FIG. 4 and FIG. 5.

Each cluster C1.1, C1.2 generated according to the second implementation just described is a three-dimensional topologically connected set of voxels. However, the cluster C1.1, C1.2 is not necessarily gap-free.

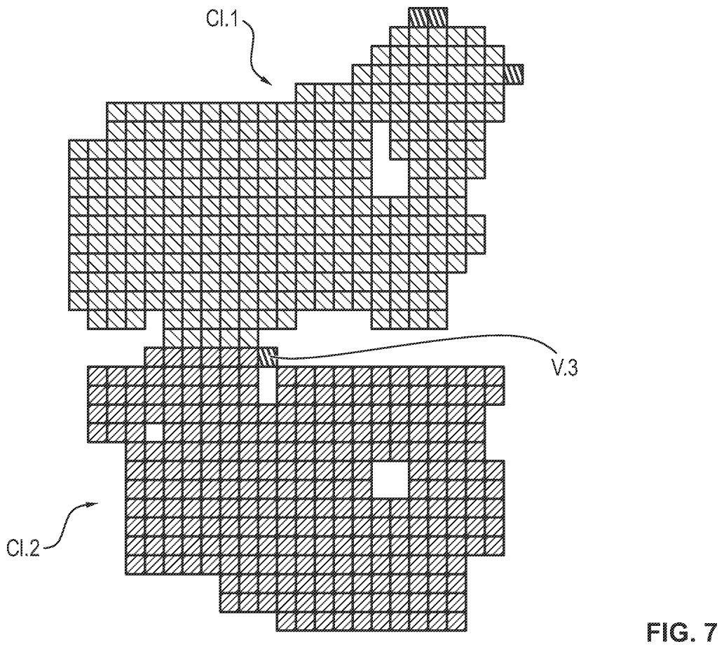

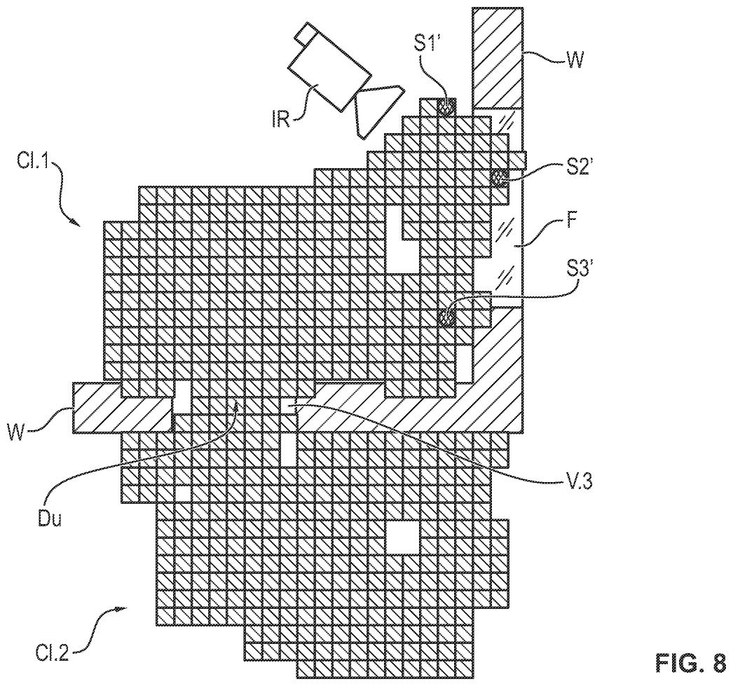

FIG. 7 shows the two clusters C1.1 and C1.2 generated in the way just described. The generated clusters C1.1 and C1.2 are also three-dimensional objects in the three-dimensional coordinate system. FIG. 8 shows the projection in the x-y plane. The starting points are the core voxels Vk.1 and Vk.2. The free voxels of the clusters C1.1 and C1.2 as well as occupied and unclassified voxels at the edges and inside the clusters, for example the occupied voxel V.3, are shown.

FIG. 8 shows the two clusters C1.1 and C1.2 of FIG. 7 as well as the wall W, the passage Du, the infrared camera IR and displaced key points S1′, S2′, S3′ of FIG. 2.

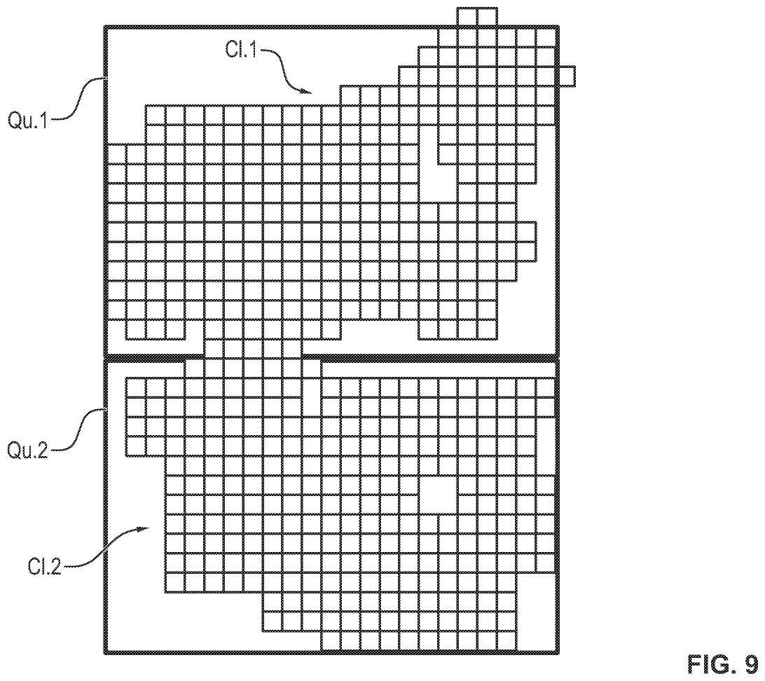

A room often has the shape of a cuboid or consists of several cuboids. Therefore, an enveloping body in the shape of a cuboid is placed around each cluster C1.1, C1.2 as a test. FIG. 9 shows the projections of the clusters in the x-y plane and the projections of the two cuboids Qu.1, Qu.2 placed around the two clusters C1.1, C1.2, i.e. two rectangles which do not overlap. If the volume of the room filled by the cluster C1.1, C1.2 in the cuboid Qu.1, Qu.2 is above a specified proportion threshold in relation to the volume of the cuboid Qu.1, Qu.2, the room is considered to be cuboidal, and the cuboid Qu.1, Qu.2 describes the boundaries (floor, ceiling, walls) of this room. Otherwise, a line segment is placed around the projection of the cluster C1.1, C1.2 on the x-y plane. This line segment describes approximately the floor plan of the room. Vertical planes, which describe the walls, are placed over the individual lines of the line segment.

FIG. 10 shows as an example several clusters Zus.1, Zus.2, . . . , which were generated as just described and describe the rooms R.1, R.2, . . . of FIG. 1. The cluster Zus.F1 describes the corridor F1. In addition, the trajectory Tr is entered. FIG. 11 shows the projections R.1, R.2 of the cuboids placed around these clusters Zus.1, Zus.2, . . . as described with reference to FIG. 9.

While specific embodiments of the invention have been shown and described in detail illustrate the application of the principles of the invention, it will be understood that the invention may be embodied otherwise without departing from such principles.

List of reference characters

| | |
|---|---|
| Cl.1, Cl.2 | Clusters of voxels around the core voxels Vk.1, |
| | Vk.2, each describe a room |
| Du | Passage in the wall W of the room R.x |
| Eb | Horizontal plane onto which the n superimposed |
| | voxels of the kernel Ke.1 are mapped |
| F | Window in the wall W of the room R.x |
| Fl | Hallway in floor plan |
| IMS | Inertial sensor unit of a firefighter, is capable |
| | of measuring the three linear accelerations and |
| | the three angular accelerations in space, |
| | measures the current position and orientation |
| | of the camera IR, in one embodiment functions |
| | as a position sensor transducer |
| IR | Infrared camera (thermal imaging camera) of a |
| | firefighter, generates infrared images |
| k | Number of neighboring key points |
| Ke.1, Ke.2 | Cuboid kernel with 7*7*3 voxels |
| N | Number of voxels in a cuboid kernel Ke.1, Ke.2 |
| n | Number of voxels that are superimposed in |
| | kernel Ke.1 |
| n_{Bew, min} | Minimum number of paths passing through a |
| | voxel for the voxel to be classified as free or |
| | occupied. |
| nₘᵢₙ | If the number of free voxels in a kernel is |
| | greater than or equal to nₘᵢₙ, the voxel in the |
| | center of the kernel is a core voxel |
| n_{Proj, min} | If at least n_{Proj, min} of the n superimposed voxels |
| | of a kernel are classified, the projection of the n |
| | voxels onto the plane Eb is classified |
| P(Vk.1) | Projection of the free core voxel Vk.1 onto the |
| | layer Eb, in which a search is performed |
| P(V.b) | Projection of an occupied voxel V.b onto the |
| | plane Eb |
| P(V.n) | Projection of an unclassified voxel V.n onto the |
| | plane Eb |
| Pos(IR) | Position of the infrared camera IR in the three- |
| | dimensional coordinate system |
| Pos(S1), Pos(S2), . . . | Position of the intersection point S1, S2 in the |
| | three-dimensional coordinate system |
| pₜₕᵣ | A voxel that is intersected by at least n_{Bew, min} |
| | paths and has a weighting smaller than pₜₕᵣ is a |
| | free voxel |
| Qu.1, Qu.2 | Cuboid around clusters Cl.1, Cl.2, acts as |
| | enveloping body |
| R.1, R.2, . . . | Rectangles placed around the faces Zus.1, Zus.2, |
| | . . . describe rectangular spaces |
| R.x | Room in the building |
| S1, S2, S3 | Key points in space R.x |
| S1.1, . . . | Key points adjacent to the key point S1 |
| S2.1, . . . | Key points adjacent to the key point S2 |
| S1′, S2′, S3′ | The shifted key point on the camera IR |
| SP | Signal processing unit which is carried by a |
| | firefighter and which carries out the process |
| | according to the invention |
| St1, St2, St3 | Path from camera IR to a key point S1′, S2′, S3′ |
| Tp | Staircase shown in the floor plan |
| V.1.1, . . . , V.7.7.3 | Voxel of the kernel Ke.1 |
| V.b | Occupied voxel |
| Vk.1, Vk.2 | Core voxel |
| V.n | Unclassified voxel |
| W | Wall of the room R.x, has the window F |
| Add.1, Add.2 | Clusters, describe the respective interior |
| | of the rooms R.1, R.2, . . . |

What is claimed is:

1. A process for generating, by using a signal processing unit, a floor plan for a story of a building, the process comprising the steps of:
specifying a three-dimensional coordinate system;
computationally generating a set of voxels such that each voxel is a polyhedron, wherein edges of the polyhedron are parallel to axes of the three-dimensional coordinate system, and wherein the voxels together enclose the story for which a floor plan is to be generated;
moving a camera through the story and with the camera, generating a sequence of images as the camera is moved;
for each image of the sequence of images, measuring a respective position and orientation of the camera at a time when the camera generates the image;
by evaluating images of the sequence of images, determining characteristic key points, each characteristic key point located on a wall of the story of the building, and at least approximately positioning the characteristic key points in the three-dimensional coordinate system;
determining free voxels, wherein each free voxel belongs to the set of voxels and is located at least once between the moved camera and at least one characteristic key point without a wall being located between the camera and the voxel, wherein for the determination of free voxels the positions of the key points and the measured positions and orientations of the moved camera are used;
generating at least one cluster such that every generated cluster forms a topologically connected set of free voxels, and each free voxel belongs to at most one cluster;
placing a respective enveloping body around every generated cluster such that no enveloping body penetrates any other enveloping body; and
generating the floor plan such that every enveloping body describes boundaries of one respective room of the story.

2. A process according to claim 1, wherein the step of generating the cluster generates a new cluster, generating the new cluster comprising the steps of:
selecting a free voxel that does not yet belong to any other cluster and using the selected free voxel as a first candidate for the new cluster;
determining whether the first candidate is a core voxel or not;
if the first candidate is a core voxel, the first candidate is a first voxel of the new cluster;
selecting at least one further free voxel as a further candidate for the new cluster,
determining whether the further candidate is a core voxel or not; and
terminating the step of generating the cluster when a specified termination criterion is met,
wherein a candidate is a core voxel if the candidate belongs to a topologically connected set of voxels, if an interior of the topologically connected set of voxels consists exclusively of free voxels, and if the topologically connected set of voxels satisfies a given number criterion depending on a number of voxels in the topologically connected set of voxels,
wherein determining whether the candidate is a core voxel or not includes generating a trial topologically connected set of voxels on a trial basis and determining whether the trial topologically connected set of voxels meets the number criterion,
wherein if the further candidate is a core voxel of the cluster, the topologically connected set of voxels is supplemented by at least the further candidate, and
wherein another free voxel of the generated topologically connected set of voxels is selected as another further candidate.

3. A process according to claim 2, wherein determining whether a candidate is a core voxel or not further comprises the steps of:
placing a polyhedron around the candidate such that the polyhedron consists of a specified number of voxels adjoining each other, the edges of the polyhedron are parallel to the axes of the three-dimensional coordinate system, and the candidate is located in a center of the polyhedron, and
generating the trial topologically connected set of voxels such that the topologically connected set of voxels consists exclusively of voxels of the polyhedron.

4. A process according to claim 3, wherein determining whether a candidate is a core voxel or not further comprises the steps of:
by a vertical projection, projecting the polyhedron being placed around the candidate onto a plane such that all superimposed voxels of the polyhedron are projected onto a same n-corner;
depending on the superimposed voxels, classifying each n-corner as a free n-corner or as another n-corner,
wherein the step of generating the trial topologically connected set of voxels on a trial basis comprises the step of generating a topologically connected set of n-corners on a trial basis, the n-corners of the generated topologically connected set of n-corners belonging to the set of n-corners generated by the projection of the polyhedron onto the plane, and
wherein the candidate is a core voxel if the generated set of n-corners satisfies a number criterion depending on the number of n-corners in the set of n-corners.

5. A process according to claim 2, wherein the trial topologically connected set of voxels is generated incrementally starting from the candidate such that no gap occurs inside the topologically connected set of voxels and such that each voxel inside the topologically connected set of voxels belongs to the generated set.

6. A process according to claim 4, wherein the trial topologically connected set of voxels is generated stepwise starting from the projection of the polyhedron onto the plane such that no gap occurs inside the topologically connected set of n-corners so each projection of an n-corner onto the plane belongs to the generated set.

7. A process according to claim 1, wherein
determining free voxels comprises the step of determining, for each voxel, each path which extends from the camera to at least one characteristic key point and passes through the voxel,
if for the voxel at least a specified minimum number of passing paths is determined, a rating of the voxel is calculated, wherein the rating depends on the number of paths passing through the voxel and/or on the respective positions of each path through the voxel relative to the center of the voxel,
depending on the rating, the voxel is classified as a free voxel or as an occupied voxel, and
if less than the specified minimum number of paths is determined for the voxel, the voxel is evaluated as an unclassifiable voxel.

8. A process according to claim 1, wherein the step of at least approximately positioning the determined characteristic key points in the three-dimensional coordinate system comprises the steps of:
for each key point and for the image showing this key point or for at least one image showing this key point, the position and orientation of the camera at the time when the camera generates the image is determined, and
each key point is moved computationally in the coordinate system towards the camera, wherein a path over which the key point is moved depends on the respective path to at least one adjacent key point, the adjacent key point being adjacent to the key point in the image.

9. A process according to claim 1, wherein the step of placing an enveloping body around the determined cluster comprises the steps of:
placing as the enveloping body a polyhedron around the cluster, such that the enveloping body being aligned parallel to the axes of the three-dimensional coordinate system, and such that the polyhedron completely envelops the cluster;
a volume of the cluster and a volume of the enveloping polyhedron are determined; and
if the volume of the cluster in relation to the volume of the polyhedron is greater than or equal to a specified proportion threshold, the enveloping polyhedron is used as the enveloping body.

10. A process according to claim 9, wherein if the cluster volume in relation to the polyhedron volume is smaller than the proportion threshold, the process further comprises the steps of:
determining two horizontal planes in such a way that the cluster is located between the two planes;
with a respective projection of the cluster perpendicular to each of the two parallel horizontal planes, projecting the cluster such that two two-dimensional projection surfaces are generated, which surfaces are parallel to each other and have the same shape;
placing a line segment around each of the two two-dimensional projection surfaces; and
using, as the enveloping body, a body bounded by the two projection surfaces and by perpendicular surfaces between these two projection surfaces.

11. An arrangement for generating a floor plan for a story of a building, the arrangement comprising:
a camera that is configured to be moved through the story and to generate a sequence of images as the camera is moved;
a position sensor that is configured to measure, for each image of the sequence of images, at a time the camera generates that image, a respective position and a respective orientation of the camera, wherein a three-dimensional coordinate system is specified; and
a signal processing unit that is configured to:
generate a set of voxels such that each voxel is a polyhedron with edges of the polyhedron that are parallel to axes of the three-dimensional coordinate system, wherein the voxels together enclose the story for which a floor plan is to be generated;
by evaluating images of the sequence of images, determine characteristic key points, each of the characteristic key points being located on a wall of the story;
position the key points at least approximately in the three-dimensional coordinate system;
determine free voxels, wherein each of the free voxels belongs to the set of voxels and is located at least once between the moved camera and a least one characteristic key point without a wall being located between the camera and the voxel;
generate at least one cluster of the voxels such that every generated cluster forms a topologically connected set of free voxels and each free voxel belongs to at most one cluster;
place a respective enveloping body around every determined cluster such that no enveloping body penetrates any other enveloping body; and
generate the floor plan such that every enveloping body describes boundaries of one respective room of the story,
wherein for the determination of free voxels the signal processing unit is configured to use positions of key points and the measured positions and orientations of the camera.
